(19) United States
(12) Patent Application Publication
(10) Pub. No.: US 2016/0275519 A1
(43) Pub. Date: Sep. 22, 2016

(54) Copyright Distribution System

(71) Applicant: SKIYAKI Inc., Tokyo (JP)

(72) Inventor: Takuya Miyase, Tokyo (JP)

(73) Assignee: SKIYAKI Inc.

(21) Appl. No.: 14/753,001

(22) Filed: Jun. 28, 2015

(30) Foreign Application Priority Data
Mar. 16, 2015 (JP) 2015-75447

(51) Int. Cl. G06Q 30/00

(52) U.S. Cl. CPC G06Q 30/01; G06Q 50/184

(57) ABSTRACT

A copyright distribution system includes a work registration function unit in which a copyright holder registers a work; a rights evaluation unit that evaluates rights in and to the registered work; a database for storing information about the copyright to the registered work; a copyright license setting unit for setting licenses (partial rights) of the copyright and/or rights relating to the registered work based on the copyright to the registered work; a settlement function unit that settles the royalties due on the use rights and pays the copyright holder; and a monetization function unit that simplifies the rights of copyright itself and clarifies what rights the copyright holder transfers and which use rights are to be set, and values the copyright using a monetization method.

### CROSS-REFERENCE TO RELATED APPLICATION

This patent application claims priority pursuant to 35 U.S.C. §119 to Japanese Patent Application No. 2015-75447, filed on Mar. 16, 2015, the entire disclosure of which is hereby incorporated by reference herein.

### BACKGROUND

1. Technical Field

The present invention relates to a copyright distribution system, and more particularly, to an optimal copyright distribution system for use in the business of distributing copyrights for artists and other copyright holders, in licensing works, and in distributing other rights relating to copyrighted works.

2. Background Art

With increasing digitalization and the expansion of the internet, an environment in which digital contents can be accessed more freely and more easily than ever before is now in place. Accordingly, to use this type of content and to copy and edit it, it is necessary to finalize contracts with the copyright holders and obtain an assignment of copyright of the content or permission to use the content.

However, to distribute copyrights of this type is at present difficult. The legal description of the rights and the interpretation of the legal terms governing them make agreements long and difficult to use. Moreover, these agreements are often bundled with a variety of different products and distributed.

Given these circumstances, copyright agreement processing support systems that create an environment in which copyright agreements can be concluded quickly and easily even by people with no prior experience of copyright agreements while still maintaining the autonomy of the copyright holder have been proposed.

However, such systems typically have complicated architectural configurations, and the support systems themselves tend to be difficult to use.

In particular, it is difficult to quantify and assign numerical values to the distribution of copyrights, and it is especially difficult to quantify copyrights across a variety of different fields, which at present makes their commercialization difficult. Moreover, at the copyright transfer stage, digitizing the copyright and defining its terms to make a viable agreement is crucial and a certain amount of complication is unavoidable.

As a result, the problems of difficulty of understanding and inability to distribute with ease that arises from copyrights, which are essentially no more than a general legal concept, are not automatically solved merely by shifting the contracts onto an IT systems platform. A genuine solution to this problem requires something more.

### SUMMARY

The present invention is conceived in light of the above-described circumstances, and has as its object to provide a copyright distribution system that lets artists, musicians, and other copyright holders retain their copyrights (the autonomy of the copyright holder) while at the same time allowing them to distribute (to share) those rights easily and flexibly, thereby enhancing the distribution itself of rights.

Embodiments of the present invention provide a novel copyright distribution system includes a work registration function unit, a rights evaluation unit, a database, a copyright license setting unit, a settlement function unit, and a monetization function unit. A work registration function unit in which a copyright holder registers a work; a rights evaluation unit that evaluates rights in and to the registered work; a database for storing information about the copyright to the registered work; a copyright license setting unit for setting licenses (partial rights) of the copyright and/or rights relating to the registered work based on the copyright to the registered work; a settlement function unit that settles the royalties due on the use rights and pays the copyright holder; and a monetization function unit that simplifies the rights of copyright itself and clarifies what rights the copyright holder transfers and which use rights are to be set, and values the copyright using a monetization method.

The copyright distribution system may be configured to simplify in advance the rights themselves of the copyright to the work; clarify which rights the copyright holder has transferred and which rights have not been transferred; and clarify and organize subject content, divide registration content for each registration field into a plurality of courses, format the plurality of courses as a menu, and configure each menu as a settable and selectable package.

The monetization function unit may be configured to create contents that render visible (visualize) the rights evaluation using the work, link the contents to a quantifiable number, and record sales; and publish recorded sales to clarify the actual state of sales.

The copyright license setting unit may be configured to divide the copyright, license, and other rights relating to a work into a plurality of rights and set their transfer or license.

The copyright license setting unit is configured to do at least one of divide the copyright, license, and other rights relating to a work that are the object of the transfer into a specific number of partial rights previously specified by the operator or assignor; reify each of the partial rights by assigning them additional information such as lot numbers, images, or text; and set the contents of the rights that the holder of the thus-reified rights can exercise.

Here, as examples of the rights related to a work as described above, there are “the right to exchange messages with the artist who created the registered work” and “the right to participate in events where the registered work is to be performed.” and the like.

Setting such rights makes it possible to provide added value not confined only to economic value to lovers of the work, thus making it possible to further promote sales distribution of rights in the copyright distribution system 1.

In addition, by setting certain specific conditions on the exercise of set rights (for example, “hold rights relating to certain other works”, or “hold rights to a certain limited number of other works provided by the same copyright holder of the work”, etc.), fans can also be prompted to purchase more rights.

According to the copyright distribution system according to the present invention, as described above, the rights contents, including copyrights, use rights (partial rights) and predefined and registered in the system and the rights contents are selected from the registered contents and the rights content are confirmed, so that, despite the uncomplicated structure, it is possible to clarify the rights contents.

Further, because the copyright distribution system according to the present invention is provided with a rights monetization (printing, distribution, etc.) capability as well as the capability to add up and publish the actual monetized value of each right, can clarify the value of the copyright.

Accordingly, the copyright distribution system 1 allows easy and flexible distribution of use rights (partial rights) while leaving the copyright in the artist or other copyright holder, thereby stimulating the distribution itself of such rights.

Further, distribution of copyrights and other rights can be completed inside the copyright distribution system 1, and moreover the copyright distribution system 1 uses a virtual currency and is provided with other settlement capabilities, and thus is equipped to pay royalties to artists and other copyright holders, so that the distribution of the rights of copyright can be carried out easily.

Further, with the above-described configuration, attendant functions such as settlement, commercialization, and public transmission are contained within the system, enabling accounting according to the digitization of the rights distribution status, and moreover making it possible to pay royalties to the artists and other copyright holders continuously each time the work is distributed.

The above-described approach makes it possible to lower transaction unit costs involved in dividing the copyright, license, and other rights relating to the work, thereby facilitating participation in such transactions by assignees. Moreover, the arrangement is good for assignors as well because the rights are only divided among a limited, specific number (i.e., the number of people capable of purchasing those rights), making it possible to promote dealing by promoting a sense of premium due to exclusivity.

Further, according to the configuration described above, the rights that are being dealt are reified, making it psychologically easy to participate in trading even for those people with no particular aptitude for or expertise in law.

Moreover, the ability to freely set the rights content without being bound by the concept of copyright law, can be defined in some of the more valuable transactions. In addition, elements of fan psychology enter in here, of interacting with the copyright holder, such as a collection of combination of right elements, making it possible to generate elements of unprecedented forms of transaction promotion.

### BRIEF DESCRIPTION OF THE DRAWINGS

A more complete appreciation of the disclosure and many of the attendant advantages thereof will be readily obtained as the same becomes better understood by reference to the following detailed description when considered in conjunction with the accompanying drawings.

FIG. 1 is a diagram showing a schematic configuration of an entire system showing one embodiment of a copyright distribution system according to the present invention;

FIG. 2 is a block diagram showing a schematic configuration of a copyright distribution system according to the present invention;

FIG. 3 is a diagram illustrating steps at the time of registration of the copyright;

FIG. 4 is a diagram illustrating an overview of the monetization functions of the copyright license in copyright distribution system according to the present invention; and

FIG. 5 is a diagram illustrating a case of distributing by dividing the rights in a copyright distribution system according to the present invention.

### DETAILED DESCRIPTION

The terminology used herein is for the purpose of describing particular embodiments only and is not intended to be limiting of this disclosure. As used herein, the singular forms “a”, “an” and “the” are intended to include the plural forms as well, unless the context clearly indicates otherwise. It will be further understood that the terms “includes” and/or “including”, when used in this specification, specify the presence of stated features, integers, steps, operations, elements, and/or components, but do not preclude the presence or addition of one or more other features, integers, steps, operations, elements, components, and/or groups thereof.

In describing example embodiments shown in the drawings, specific terminology is employed for the sake of clarity. However, the present disclosure is not intended to be limited to the specific terminology so selected and it is to be understood that each specific element includes all technical equivalents that have the same function, operate in a similar manner, and achieve a similar result.

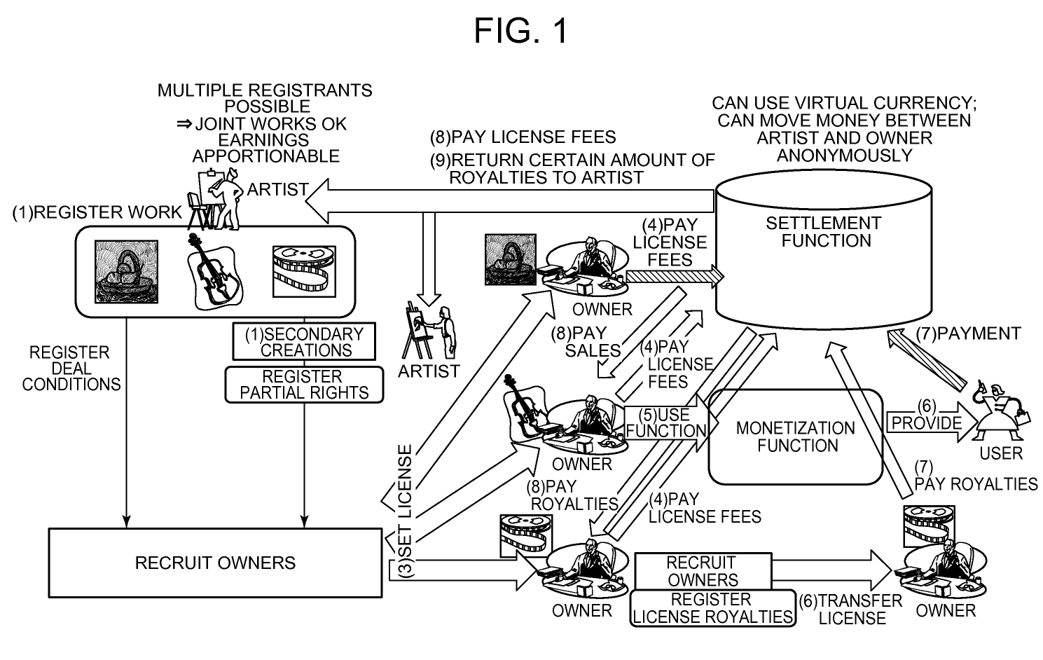

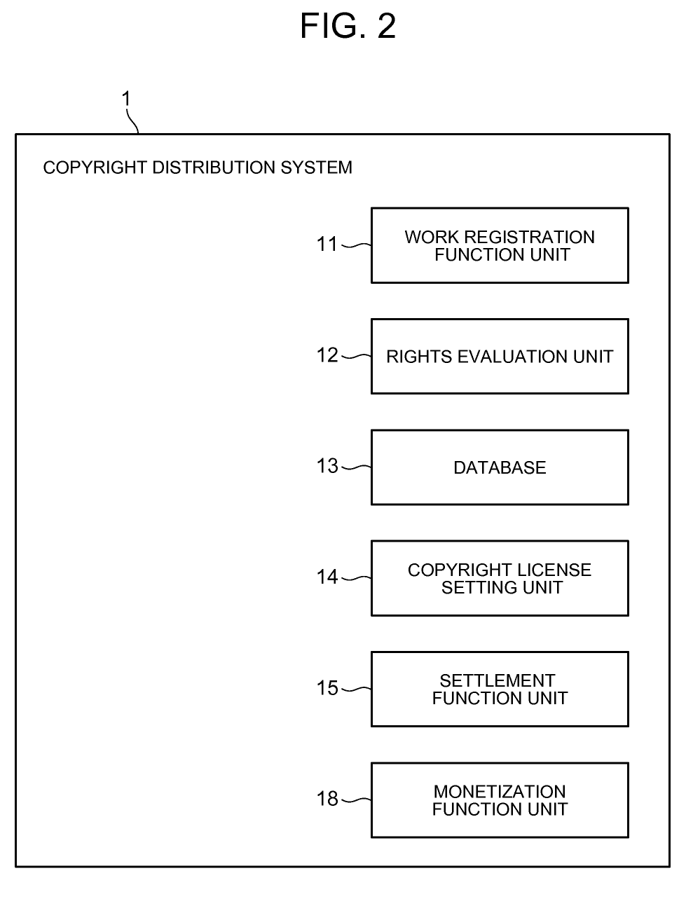

FIG. 1 shows one embodiment of a copyright distribution system according to the present invention. FIG. 2 is a block diagram showing a schematic configuration of a copyright distribution system according to the present invention;

In the drawings, a copyright distribution system 1 is provided with a work registration function unit 11 for artists and other copyright holders to register their work, a rights evaluation unit 12 to evaluate the rights to the work, a database 13 to record information about copyrights to the registered works, a copyright license setting unit 14 to set transfers and/or licenses of the copyrights based on the copyrights of the registered works, and a settlement function unit 15 to settle the royalties due to the licenses and pay the copyright holder. The settlement function unit 15 is in turn provided with a monetization function unit 18 that simplifies the copyright rights themselves and clarifies the rights that the copyright holder transfers and sets the licenses, as well as values the copyright using a monetization method.

The rights evaluation unit 12 not only simplifies in advance the rights themselves of the copyright to the work and clarifies which rights the copyright holder has transferred and which rights he has not transferred, but also clarifies and organizes the subject content, divides the registration contents for each registration field into a plurality of courses, sets them in a menu format, and configures each menu as a settable and selectable package.

That is, the copyright distribution system 1 described above evaluates the copyright rights and packages those rights. By doing so, it is possible to organize and clarify the legal aspects of the copyright.

Further, the monetization function unit 18 is configured to create contents that render visible (visualize) the rights evaluation using the work, link this to a quantification algorithm that can record sales, publish it, and make clear the actual state of sales.

That is, the copyright distribution system 1 uses a monetization scheme to value the copyright so that the copyright can be utilized effectively, thus making it possible to quantify the contents.

A description of the operation of the copyright distribution system 1 now follows.

In FIG. 1, to start, the work must be registered as a work. Specifically, terms and conditions, for example, work data (image, music, video, etc.), the monetary amount of the license royalties, are registered. This is also the case for so-called secondary creations.

Then, copyright licenses are acquired under certain conditions and owners to receive license transfers are recruited, and licenses are exercised in accordance with those rights accordingly. In response thereto, goods are manufactured and sold, and video and music are distributed, by the monetization function unit 18. The royalties resulting from each performance, namely payment of the price is carried out by the settlement function unit 15. Ultimately, the appropriate royalties are paid to the artist or other copyright holder.

In the copyright distribution system 1 described above, the process starts with the copyright holder consenting to the formatting of the rights conditions at the beginning of the registration stage. Then, by this formatting, rights relationships and rights evaluation of the copyright becomes clear, and as a result, distribution settlement using a virtual currency is carried out clearly and quickly by the settlement function unit 15, and the royalties are paid to the appropriate rights holder.

It is to be noted that, in the settlement function unit 15, by using a point system virtual currency, the details become clear and it is possible to dispense with the complexity ascribed to money, thereby providing speedy distribution, clarity, and ease of handling.

Here, the maximum point of the copyright distribution system 1, it is possible to handle a copyright as a license, thereby making it possible to transfer a copyright and to pay royalties in the distribution stage rather than at the end after selling the copyright. Taking a transaction fee during that process is to be regarded as the value of the process of distribution.

That is, with the copyright distribution system 1 described above, by acquiring legal consent during the distribution, using a virtual currency, and by treating the process as a process value arising from handling as licenses, the required distribution effect can be achieved.

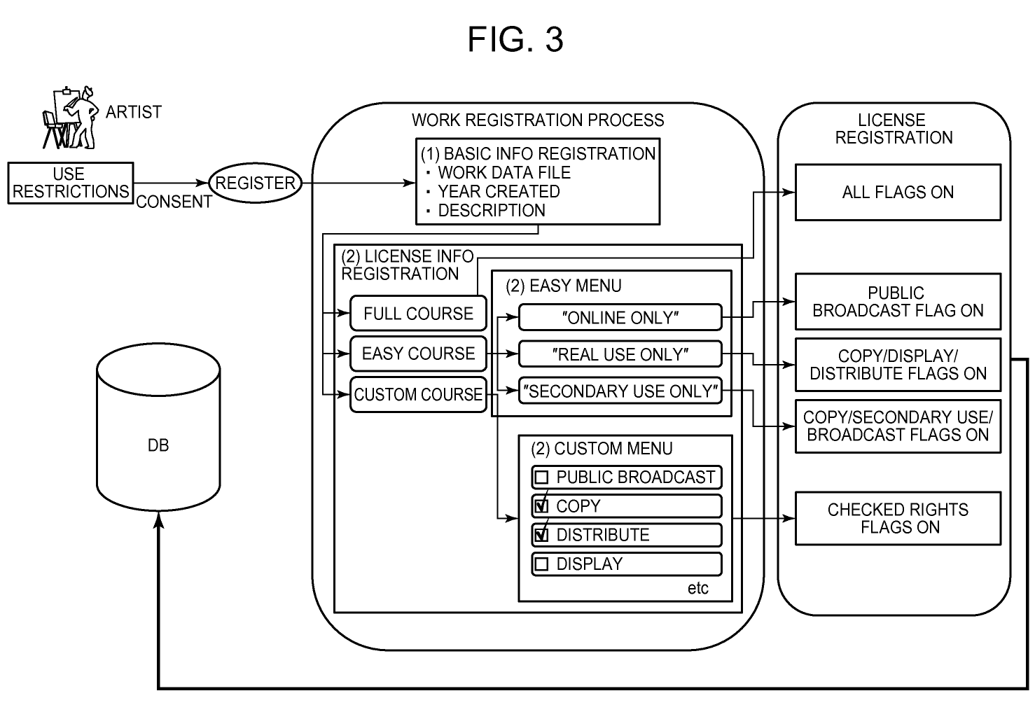

FIG. 3 is a diagram illustrating steps at the time of registration of the copyright in the registration function unit 11 in the copyright distribution system 1 described above. In this process, the copyright owner registers the painting, performance or other such work, by which the painting or video is represented. Royalties due on the license are handled and any required information, such as the rights content, is published.

Here, in the licensing information registration, multiple courses are preset and license registration is performed according to the course that is selected.

A buyer (hereinafter “owner”) who purchases such copyright licenses, by buying the license, engages in the following:

1. Attracting customers using animated or cartoon characters
2. Leasing ownership as an owner and marketing rights activities
3. Printing of a design and marketing goods with the design
4. Selling (transferring) ownership to another owner

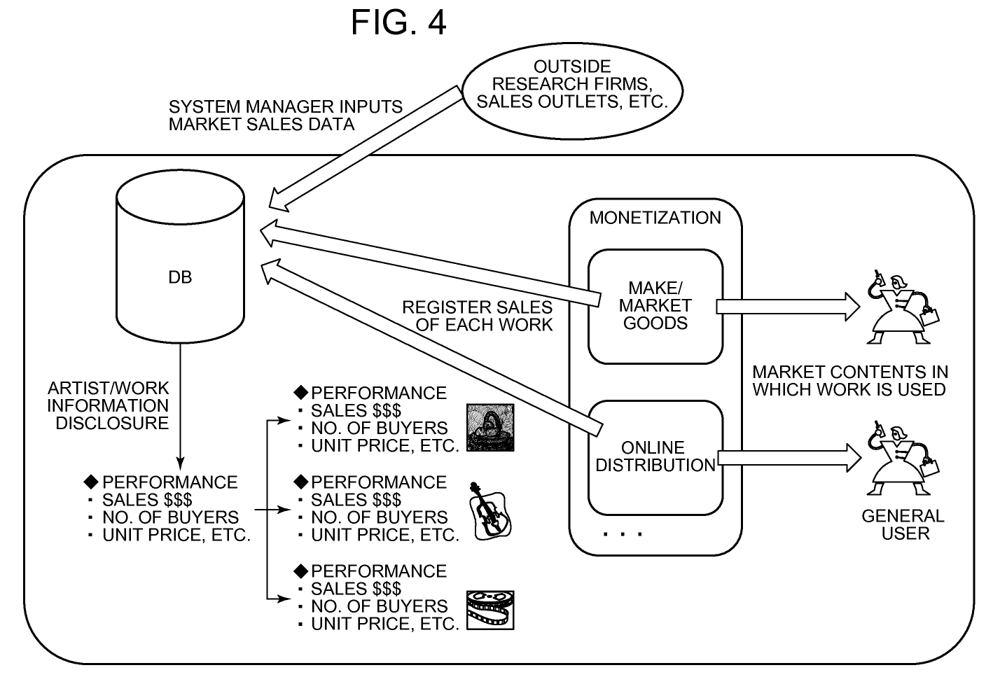

FIG. 4 is a diagram illustrating an overview of the monetization functions of the copyright license in copyright distribution system according to the present invention. More particularly, FIG. 4 Illustrates movement in the monetization function unit 18; depending on the type of work that is recorded in the database 13, the monetization function unit 13 shows goods manufacture and sales, or the state of network distribution, etc., of video, etc.

It should be noted that, in copyright distribution system 1 described above, IDs are distributed in advance to the artists and the owners. In addition, as a mechanism to ensure compliance, a system to check for instances of plagiarism is provided together with associated consent forms. Use of the ID prevents names from getting out while business is being transacted.

Further, because the settlement function unit 15 uses a virtual currency, the procedure is simple and artists can be easily compensated for the use of their work. It is advantageous for system operation if fees are taken the stage of final payment of such virtual currency.

As described above, in the copyright distribution system 1 as described above, copyright, and confirm the license to use pre-defined rights contents of the use rights (partial rights) or the like is registered in the system, the right content selected from the registration contents Since it is such that, despite a simple configuration, it is possible to clarify the rights contents.

Also, because the copyright distribution system 1 is provided with a rights content monetization (printing, distribution, etc.) capability as well as the ability to add up the actual monetized value of each right and publish the total, it is possible to clarify the value of the copyright.

Accordingly, the copyright distribution system 1 allows easy and flexible distribution of use rights (partial rights) while leaving the copyright in the artist or other copyright holder, thereby stimulating the distribution itself of such rights.

Further, distribution of copyrights and other rights can be completed inside the copyright distribution system 1, and moreover the copyright distribution system 1 uses a virtual currency and is provided with other settlement capabilities, and thus is equipped to pay royalties to artists and other copyright holders, so that the distribution of the rights of copyright can be carried out easily.

Further, with the above-described configuration, attendant functions such as settlement, commercialization, and public transmission are contained within the system, enabling accounting according to the digitization of the rights distribution status, and moreover making it possible to pay royalties to the artists and other copyright holders continuously each time the work is distributed.

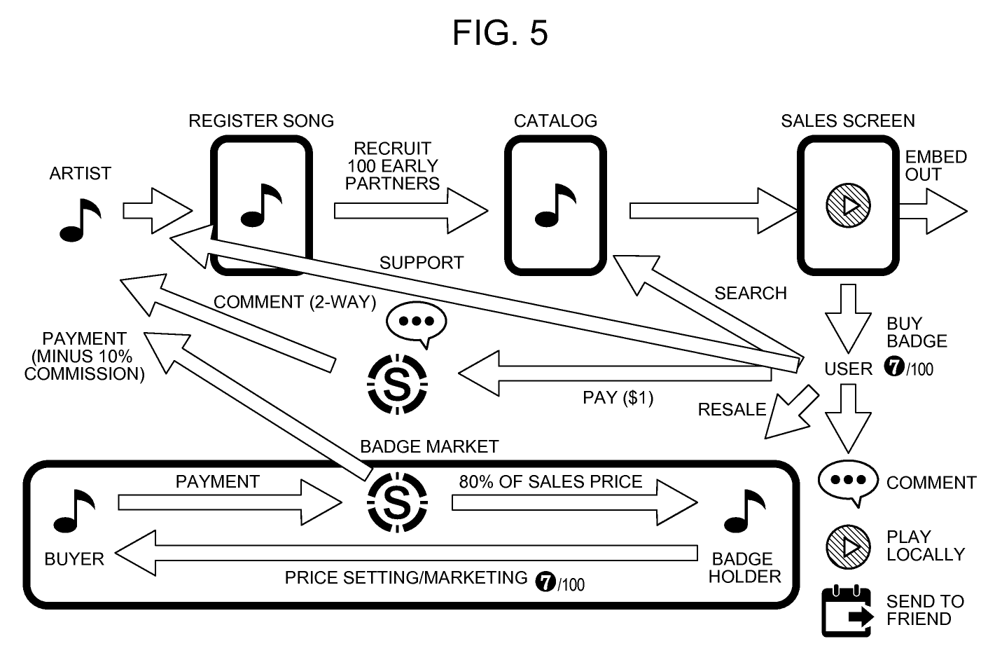

FIG. 5 shows another embodiment of a copyright distribution system according to the present invention. In this embodiment, copyrights, licenses, and other rights to works are divided into a plurality of rights related to the work to carry out transfer or license settings.

That is, upon dealing a copyright or a license as a single right, from the fact that it is necessary for the assignor or the user to ensure profitability solely from the instant transaction, they are sometimes forced to set a high transaction price. In that case, since the assignee or user is also to forced to bear high costs, it is often the case that a beginner or a person without sufficient funds will not be able to participate freely in such transactions.

In addition, in law the concept of copyright is built on the idea of traditional rights, that is, the exercise of rights in an exclusive way by a particular person. By contrast, in modern times, it sometimes happens that untold numbers of people making use of sophisticated networks and computers to use, modify, and distribute works (actions that in law amount to copyright infringement) serve only to heighten awareness and appeal of the work, with the result that the value of the work is increased. As a result, the monetization of copyrights needs some mechanism whereby it can easily deal with the actual state of distribution of the work, including situates such as the phenomenon just described.

Therefore, according to the present invention, the copyright license setting unit 14 is configured to divide the copyright, license, and other rights relating to a work into a plurality of rights and set their transfer or license. More specifically, the copyright license setting unit 14 has the capability to do one or all of the following: divide the copyright, license, and other rights relating to a work that are the object of the transfer into a specific number of partial rights previously specified by the operator or assignor; reify each of the partial rights (for example, by assigning them additional information such as lot numbers, images, or text); and set the contents of the rights that the holder of the thus-reified rights can exercise (for example, the ability to assert the copyright, the opportunity to engage the copyright holder, the provisions of partial rights that enable purchase only by someone possessing a specific combination of rights, etc.).

In the copyright distribution system 1 according to the above-described configuration, for example, as a means of distributing the copyright to a piece of music registered as a work, a case of issuing 100 tickets (referred to, for example, as “badges”) dividing that piece of music into 100 is illustrated in FIG. 5.

First, once the music is registered, users are recruited until the limit of 100 persons as partners is reached. In this case, whether that ticket is 100 yen or 1,000 yen is unspecified. The recruited partners receive the distribution service of the music.

Besides music distribution, for example, the copyright distribution system 1 can also organize a variety of events, and can carry out handshake meetings, signing sessions, message exchange sessions.

In the above-described case, limiting the applicants (partners) to a predetermined characteristic number, for example 100 people, puts a premium on the rights and the value is amplified.

In this case, the rule is first-come-first-serve. However, if the rule varies depending on the piece of music, there may be 100,000 or 200,000 applicants, in which case that premium can be signaled via a bulletin board.

In addition, if there is a request from a producer or a promoter wishing to purchase when a certain number of people apply, for example 100, the process can be upgraded to a negotiation to transfer those rights.

Here, the above-described ticket (badge) can be used as follows:

1) up to 100, the payment of 90% of the profits minus the 10 percent sales commission to the music registrant,
2) 100 partners, each to be sold to the purchaser (producer, promoter, other partners), to return 10% of the selling price to the music registrant.

In addition, in a case in which the applicants (partners) register several pieces of music the copyright distribution system 1 office may give applicants (partners) preference points, and offer the applicants promotional points for every 10 cases, for example.

The above-described approach makes it possible to lower transaction unit costs involved in dividing the copyright, license, and other rights relating to the work, thereby facilitating participation in such transactions by assignees. Moreover, the arrangement is good for assignors as well because the rights are only divided among a limited, specific number (i.e., the number of people capable of purchasing those rights), making it possible to promote dealing by promoting a sense of premium due to exclusivity.

Further, according to the configuration described above, the rights that are being dealt are reified, making it psychologically easy to participate in trading even for those people with no particular aptitude for or expertise in law.

Moreover, the ability to freely set the rights content without being bound by the concept of copyright law, can be defined in some of the more valuable transactions. In addition, elements of fan psychology enter in here, of interacting with the copyright holder, such as a collection of combination of right elements, making it possible to generate elements of unprecedented forms of transaction promotion.

Here, as examples of the rights related to a work as described above, there are “the right to exchange messages with the artist who created the registered work” and “the right to participate in events where the registered work is to be performed.” and the like.

Setting such rights makes it possible to provide added value not confined only to economic value to lovers of the work, thus making it possible to further promote sales distribution of rights in the copyright distribution system 1.

In addition, by setting certain specific conditions on the exercise of set rights (for example, “hold rights relating to certain other works”, or “hold rights to a certain limited number of other works provided by the same copyright holder of the work”, etc.), fans can also be prompted to purchase more rights.

The above-described embodiments are illustrative and do not limit this disclosure. Thus, numerous additional modifications and variations are possible in light of the above teachings. For example, elements or features of different illustrative and embodiments herein may be combined with or substituted for each other within the scope of this disclosure and the appended claims. Further, features of components of the embodiments, such as number, position, and shape, are not limited to those of the disclosed embodiments and thus may be set as preferred. Further, the above-described steps are not limited to the order disclosed herein. It is therefore to be understood that, within the scope of the appended claims, this disclosure may be practiced otherwise than as specifically described herein.

For example, although the settlement function unit 15 is described above as using a virtual currency using points, alternatively other appropriate payment methods may be employed as appropriate.

### LIST OF REFERENCE NUMERALS

1 Copyright distribution system
11 Work registration function unit
12 Rights evaluation unit
13 Database
14 Copyright license setting unit
15 Settlement function unit
18 Monetization function unit

What is claimed is:

1. A copyright distribution system comprising:
a work registration function unit in which a copyright holder registers a work;
a rights evaluation unit that evaluates rights in and to the registered work;
a database for storing information about the copyright to the registered work;
a copyright license setting unit for setting licenses (partial rights) of the copyright and/or rights relating to the registered work based on the copyright to the registered work;
a settlement function unit that settles the royalties due on the use rights and pays the copyright holder; and
a monetization function unit that simplifies the rights of copyright itself and clarifies what rights the copyright holder transfers and which use rights are to be set, and values the copyright using a monetization method.

2. The copyright distribution system according to claim 1, wherein the rights evaluation unit is configured to:
simplify in advance the rights themselves of the copyright to the work;
clarify which rights the copyright holder has transferred and which rights have not been transferred; and
clarify and organize subject content, divide registration content for each registration field into a plurality of courses, format the plurality of courses as a menu, and configure each menu as a settable and selectable package.

3. The copyright distribution system according to claim 1, wherein the monetization function unit is configured to:
create contents that render visible (visualize) the rights evaluation using the work, link the contents to a quantifiable number, and record sales; and
publish recorded sales to clarify the actual state of sales.

4. The copyright distribution system according to claim 1, wherein the copyright license setting unit is configured to divide the copyright, license, and other rights relating to a work into a plurality of rights and set their transfer or license.

5. The copyright distribution system according to claim 4, wherein the copyright license setting unit is configured to do at least one of:
divide the copyright, license, and other rights relating to a work that are the object of the transfer into a specific number of partial rights previously specified by the operator or assignor;
reify each of the partial rights by assigning them additional information such as lot numbers, images, or text; and
set the contents of the rights that the holder of the thus-reified rights can exercise.
